(19) United States
(12) Patent Application Publication
(10) Pub. No.: US 2024/0204952 A1
(43) Pub. Date: Jun. 20, 2024

(54) REFERENCE SIGNALING DESIGN AND CONFIGURATION

(71) Applicant: ZTE Corporation, Shenzhen, Guangdong (CN)

(72) Inventors: Shujuan ZHANG, Shenzhen (CN); Bo GAO, Shenzhen (CN); Minqiang ZOU, Shenzhen (CN); Zhaohua LU, Shenzhen (CN)

(21) Appl. No.: 18/529,432

(22) Filed: Dec. 5, 2023

Related U.S. Application Data
(63) Continuation of application No. PCT/CN2022/090645, filed on Apr. 29, 2022.

(51) Int. Cl. H04L 5/00

(52) U.S. Cl. CPC H04L 5/0051

(57) ABSTRACT

Method and systems for reference signaling design and configuration are disclosed. In an implementation, a method of wireless communication includes determining, by a communication device, one or more channel status information reference signal resources, receiving, by the communication device, channel status information reference signal on the one or more channel status information reference signal resources, and reporting, by the communication device, to a communication node, channel state information including first information about one set of first type of vectors, second information about one or more sets of second type of vectors, and third information corresponding to D time domain units.

### CROSS REFERENCE TO RELATED APPLICATIONS

This patent document is a continuation of and claims benefit of priority to International Patent Application No. PCT/CN2022/090645, filed on Apr. 29, 2022. The entire content of the before-mentioned patent application is incorporated by reference as part of the disclosure of this application.

### TECHNICAL FIELD

This patent document is directed generally to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques for reference signaling design and configuration.

In one aspect, a method of data communication is disclosed. The method includes determining, by a communication device, one or more channel status information reference signal resources, receiving, by the communication device, channel status information reference signal on the one or more channel status information reference signal resources, and reporting, by the communication device, to a communication node, channel state information including first information about one set of first type of vectors, second information about one or more sets of second type of vectors, and third information corresponding to D time domain units, wherein each of the first type of vectors includes P/2 elements, wherein P is a number of channel status information reference signal ports of one of the one or more channel status information reference signal resources, each second type of vector includes C elements each of which corresponds to one frequency domain unit, wherein each of C and D is a positive integer, or at least one of C or D is a positive integer larger than 1.

In another aspect, a method of data communication is disclosed. The method includes determining, by a communication device, one or more channel status information reference signal resources, receiving, by the communication device, channel status information reference signal on the one or more channel status information reference signal resources, and transmitting, by the communication device to a first communication node, information about E channels between the communication device and a second communication node, wherein E is a positive integer.

In another example aspect, a wireless communication apparatus comprising a processor configured to implement an above-described method is disclosed.

In another example aspect, a computer storage medium having code for implementing an above-described method stored thereon is disclosed.

These, and other, aspects are described in the present document.

### BRIEF DESCRIPTION OF THE DRAWING

FIG. 1 shows an example of a wireless communication system based on some example embodiments of the disclosed technology.

FIG. 2 is a block diagram representation of a portion of an apparatus based on some embodiments of the disclosed technology.

FIG. 3 shows an example of time domain units based on some example embodiments of the disclosed technology.

FIG. 4 shows an example of a period for reporting different portions of channel status information (CSI) based on some example embodiments of the disclosed technology.

FIG. 5 shows another example of a period for reporting different portions of CSI based on some example embodiments of the disclosed technology.

FIG. 6 shows an example of CSI reporting based on some example embodiments of the disclosed technology.

FIG. 7 shows another example of CSI reporting based on some example embodiments of the disclosed technology.

FIG. 8 shows an example of a process for wireless communication based on some example embodiments of the disclosed technology.

FIG. 9 shows another example of a process for wireless communication based on some example embodiments of the disclosed technology.

### DETAILED DESCRIPTION

Section headings are used in the present document only for ease of understanding and do not limit scope of the embodiments to the section in which they are described. Furthermore, while embodiments are described with reference to 5G examples, the disclosed techniques may be applied to wireless systems that use protocols other than 5G or 3GPP protocols.

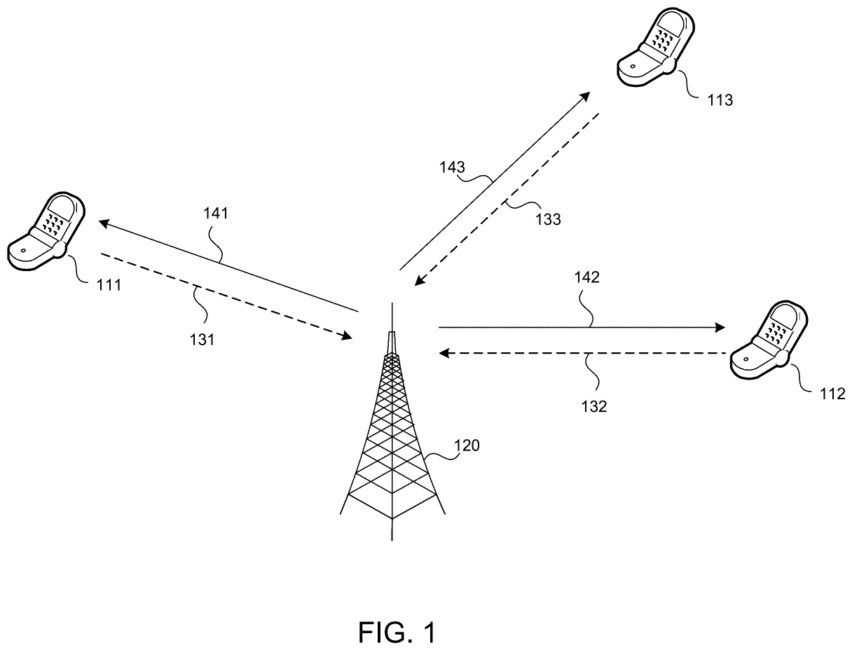

FIG. 1 shows an example of a wireless communication system (e.g., a long term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. The UE may be, for example, a smartphone, a tablet, a mobile computer, a machine to machine (M2M) device, a terminal, a mobile device, an Internet of Things (IOT) device, and so on.

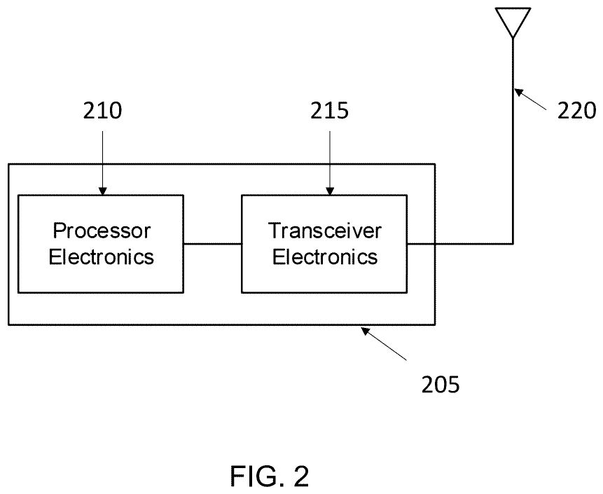

FIG. 2 is a block diagram representation of a portion of an apparatus based on some embodiments of the disclosed technology. An apparatus 205 such as a network device or a base station or a wireless device (or UE), can include processor electronics 210 such as a microprocessor that implements one or more of the techniques presented in this document. The apparatus 205 can include transceiver electronics 215 to send and/or receive wireless signals over one or more communication interfaces such as antenna(s) 220. The apparatus 205 can include other communication interfaces for transmitting and receiving data. Apparatus 205 can include one or more memories (not explicitly shown) configured to store information such as data and/or instructions. In some implementations, the processor electronics 210 can include at least a portion of the transceiver electronics 215. In some embodiments, at least some of the disclosed techniques, modules or functions are implemented using the apparatus 205.

### EXAMPLE 1

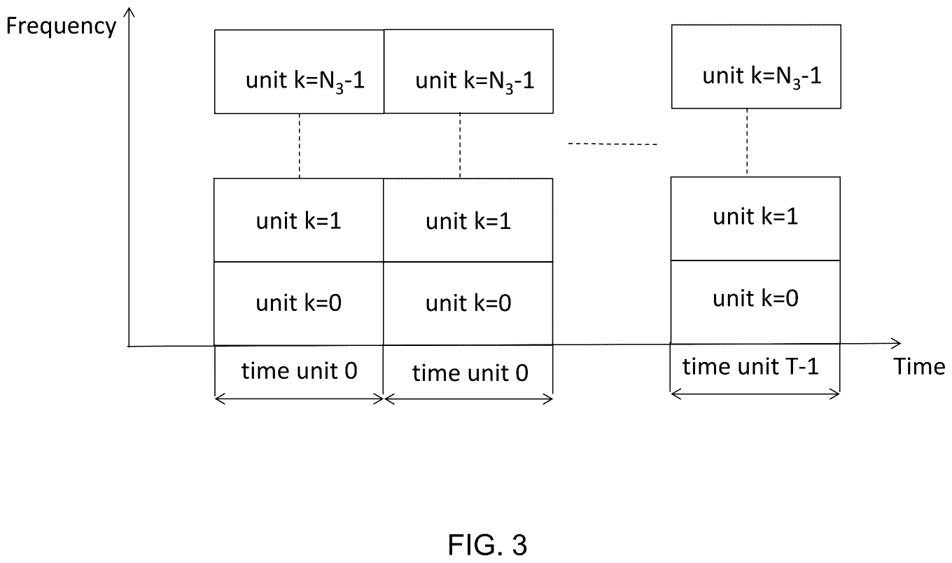

FIG. 3 shows an example of time domain units based on some example embodiments of the disclosed technology.

The UE reports a precoding matrix indicator (PMI, i.e., the channel state information) which indicates N₃*T precoding matrices for N₃ frequency domain units and T time domain units. The N₃*T precoding matrices include N₃ precoding matrices for N₃ frequency domain units of each of the T time domain units. Each of N₃ precoding matrices for one time domain units corresponds to one of N₃ frequency domain units.

In some implementations, the value T is larger than 1.

In some implementations, the value N₃ is larger than 1.

For example, the l^{th} column W_{k,t}^{l} of one precoding matrix W_{k,t} for a frequency domain unit k,k=0,1 . . . N₃−1 and a time domain unit t,t=0,1 . . . , T−1 can have the following format:

$${W}_{t}^{l} = \frac{1}{{β}_{l , k , t}} [ \begin{matrix}{\sum }_{i = 0}^{L - 1} {v}_{i} & {\sum }_{f = 0}^{M - 1} {y}_{k , l}^{( f )} & {\sum }_{x = 0}^{X - 1} {s}_{l , i , f , t}^{x} {a}_{l , i , f , x} \\ {\sum }_{i = 0}^{L - 1} {v}_{i} & {\sum }_{f = 0}^{M - 1} {y}_{k , l}^{( f )} & {\sum }_{x = 0}^{X - 1} {s}_{l , i , f , t}^{x} {a}_{l , i + L , f , x}\end{matrix} ]$$

wherein vᵢ is a first type of vector which includes P elements and also can be referred to as spatial domain vector. Each of P elements corresponds to one CSI-RS port of P CSI-RS ports of a CSI-RS resource which the PMI is based on. P is the number of one CSI-RS resource. In some implementations, vᵢ is a Discrete Fourier Transform (DFT) or 2 dimension DFT with P elements. In another implementation, vᵢ is a vector with only one element that equals 1 and the remaining

$$\frac{P}{2} - 1$$

elements are 0.

$${y}_{k , l}^{( f )} = {e}^{j 2 π \frac{{n}_{3 , l}^{f} * k}{{N}_{3}}} ,$$

$${n}_{3}^{f} ∈ \{ 0 , 1 , … , {N}_{3} - 1 \} .$$

For one n_{3,l}^{f},N₃ of y_{k,l}^{(f)} can be viewed as a vector that can be referred to as a second type of vector or frequency domain vector. s_{l,i,f,t}^{x} is t^{th} element of a third type of vector which corresponds to a time domain unit t.

$${s}_{l , i , f , t}^{x} = {e}^{j 2 π \frac{{u}_{l , i , {f}^{t}}^{x}}{T}} ,$$

$${u}_{l , i , f}^{x} ∈ \{ 0 , 1 , … , T - 1 \} .$$

For one u_{l,i,f}^{x}, T of s_{l,i,f,t}^{x} can be viewed as a vector that can be referred to as a third type of vector or time domain vector. In a second implementation,

$${s}_{l , i , f , t}^{x} = {e}^{j 2 π \frac{{u}_{l , i , {f}^{t}}^{x}}{T * {Q}_{T}}} ,$$

$${u}_{l , i , f}^{x} ∈ \{ 0 , 1 , … , T * {Q}_{T} - 1 \} .$$

In a third implementation, s_{l,i,f,t}^{x}=e^{j2πu}^{ₗ}^{^{x}}^{_{,i,f}}^{^{t}}, wherein u_{l,i,f}^{x} is a reported reasonable number.

In some implementations, the T time domain units are continuous. The next orthogonal frequency division multiplexing (OFDM) symbol of the end of the time domain unit t−1 is the starting OFDM symbol of the time domain unit t.

In some implementations, the T time domain units include the same number of OFDM.

The PMI includes information about three types of vectors for each layer l,l=1,2, . . . v. The column corresponding to the layer l of all of the N₃*T precoding matrices is based on the reported three type of vectors. The PMI includes information about one vector, which means that the PMI includes an index corresponding to the one vector. For example, the PMI includes n_{3,l}^{f},u_{l,i,f}^{f}.

### EXAMPLE 2

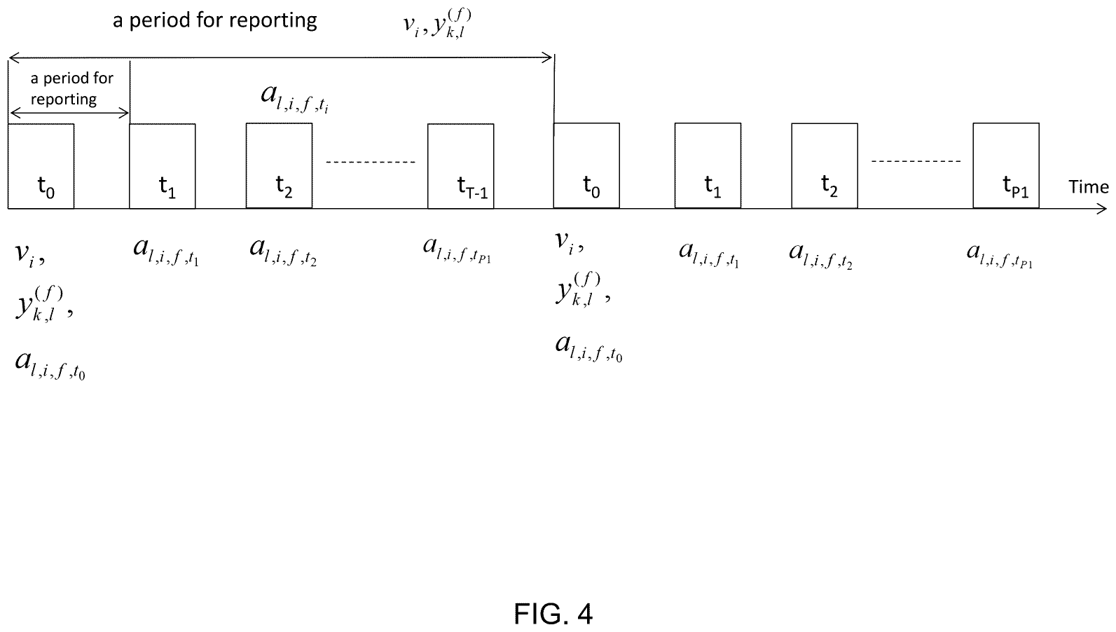

FIG. 4 shows an example of a period for reporting different portions of channel status information (CSI) based on some example embodiments of the disclosed technology.

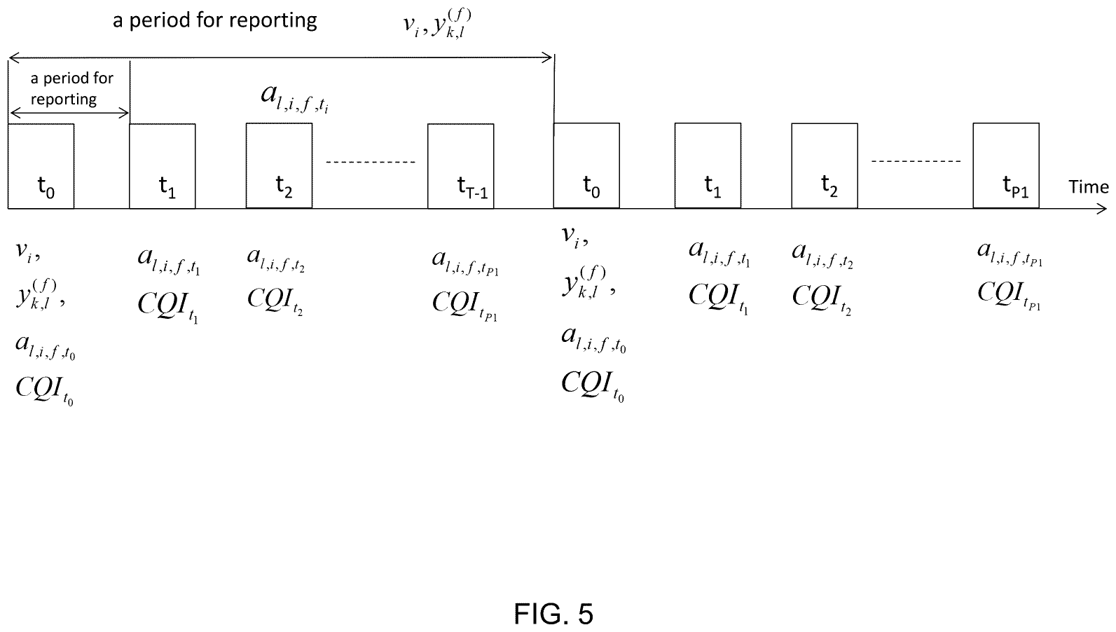

FIG. 5 shows another example of a period for reporting different portions of CSI based on some example embodiments of the disclosed technology.

The period for reporting different parts of CSI can be different.

As shown in FIG. 4, the period of reporting vᵢ,y_{k,l}^{f} is a first period, the period of reporting a_{l,i,f,t} is a second period. The first period includes multiple second periods. The reported a_{l,i,f,t} is based on a latest reported vᵢ,y_{k,l}^{f}.

As shown in FIG. 5, the period of reporting vᵢ,y_{k,l}^{f} is a first period, the period of reporting a_{l,i,f,t},CQIₜ is a second period. The first period includes multiple second periods. The reported a_{l,i,f,t},CQIₜ is based on a latest reported vᵢ,y_{k,l}^{f}.

For example, the l^{th} column W_{k,t}^{l} of one precoding matrix W_{k,t} for a frequency domain unit k,k=0,1 . . . N₃−1 and a time domain unit t, t=0,1 . . . , T−1 can have the following format:

$${W}_{t}^{l} = [ \begin{matrix}{\sum }_{i = 0}^{L ‐ 1} {v}_{i} {\sum }_{f = 0}^{M ‐ 1} {y}_{k , l}^{( f )} {a}_{l , i , f , t} \\ {\sum }_{i = 0}^{L ‐ 1} {v}_{i} {\sum }_{f = 0}^{M ‐ 1} {y}_{k , l}^{( f )} {a}_{l , i + L , f , t}\end{matrix} ]$$

### EXAMPLE 3

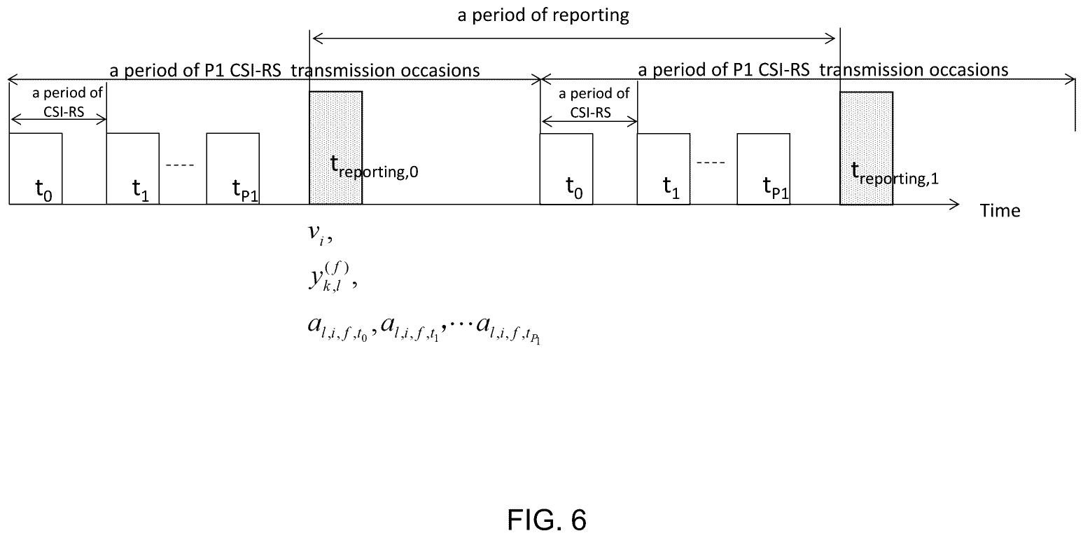

FIG. 6 shows an example of channel status information (CSI) reporting based on some example embodiments of the disclosed technology.

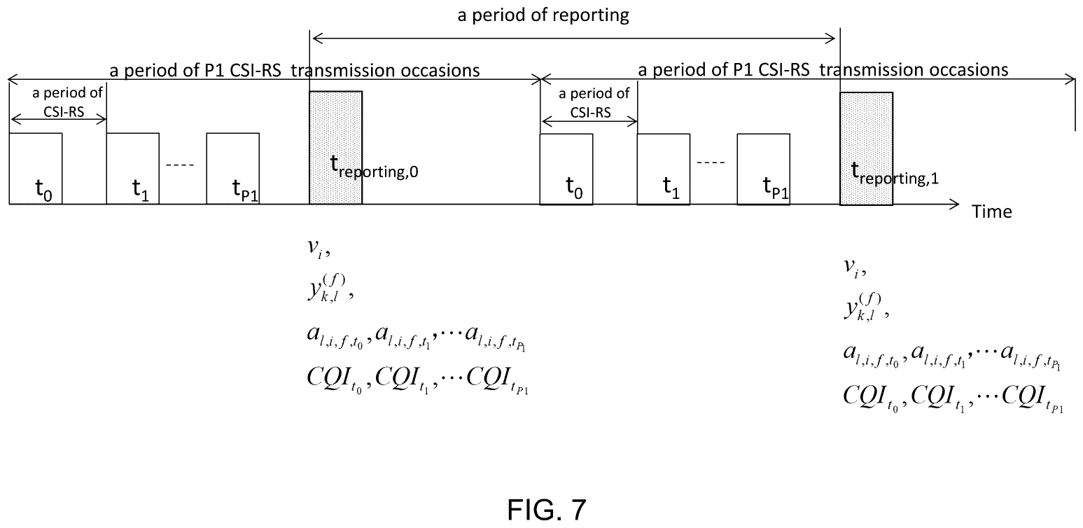

FIG. 7 shows another example of CSI reporting based on some example embodiments of the disclosed technology.

For the one reporting that is reported at one time stance and on one uplink channel, it includes one set of first CSI information and multiple sets of second CSI information, which correspond to multiple time domain units. The one set of first CSI information can be applied to the multiple time domain units. Each of the multiple time domain units corresponds to one respective set of second CSI information.

As shown in FIG. 6, the UE reports CSI for one CSI reporting in one time stance such as on each time stance t_{reporting,i},i=0,1, . . . , the UE reports one set of vᵢ,y_{k,l}^{f} and P1 sets of a_{l,i,f,t}, wherein P1 is larger than 1.

As shown in FIG. 7, the UE reports CSI for one CSI reporting in one time stance such as on each time stance reporting t_{reporting,i},i=0,1, . . . , the UE reports one set of vᵢ,y_{k,l}^{f} and P1 sets of a_{l,i,f,t},CQIₜ.

For example, the l^{th} column W_{k,t}^{l} of one precoding matrix W_{k,t} for a frequency domain unit k,k=0,1 . . . N₃−1 and a time domain unit t, t=0,1 . . . , T−1 can have the following format:

$${W}_{t}^{l} = [ \begin{matrix}{\sum }_{i = 0}^{L ‐ 1} {v}_{i} {\sum }_{f = 0}^{M ‐ 1} {y}_{k , l}^{( f )} {a}_{l , i , f , t} \\ {\sum }_{i = 0}^{L ‐ 1} {v}_{i} {\sum }_{f = 0}^{M ‐ 1} {y}_{k , l}^{( f )} {a}_{l , i + L , f , t}\end{matrix} ]$$

The disclosed technology can be implemented in some embodiments to provide the third type of vector as discussed above.

### EXAMPLE 4

Legacy structure for W₁, W₂ and W_{f} remains, but additional eigen-vector and corresponding matrix U (e.g., by additional W₁, W₂ and W_{f}, or only the portion of them) are introduced. Then, we may consider a prediction/extrapolation structure for the eigen-vector.

Similar to interpretation-2, this interpretation-3 is also relevant to CSI/PMI prediction/extrapolation, but is based on full channel matrix H=UΣV^{H}. Although it may introduce some more CSI feedback compared with the legacy report of matrix W=W₁W₂W_{f}^{H}, i.e., matrix V-only, it can explain the full channel information which may be beneficial for Doppler prediction and the subsequent CSI compression.

In above implementation, an symbol index in a down subscript or in a up subscript of a vector or a matrix means that the vector or the matrix is specific to the index. For example, n_{3,l}^{f} is specific to a layer l and local index of a second type of vector f. The integer in a down subscript or in a up subscript of a vector or a matrix doesn't mean that the vector or the matrix is specific to the integer and it just means a category of the vector or matrix. For example, the subscript 3 of n_{3,l}^{f} means a category of n.

In some implementations, the period for reporting different portions of CSI can be different.

The disclosed technology can be implemented in some embodiments to determine which CSI information is reported in a first period and which CSI information is reported in a second period. In addition, the disclosed technology can be implemented in some embodiments to determine the relationship between the first period and the second period.

In some implementations, one reporting reported at one time stance and on one uplink channel includes one set of first CSI information and multiple sets of second CSI information which corresponds to multiple time domain units.

In some implementations, the one set of first CSI information can be applied to the multiple time domain units. Each of the multiple time domain units corresponds to a set of second CSI information.

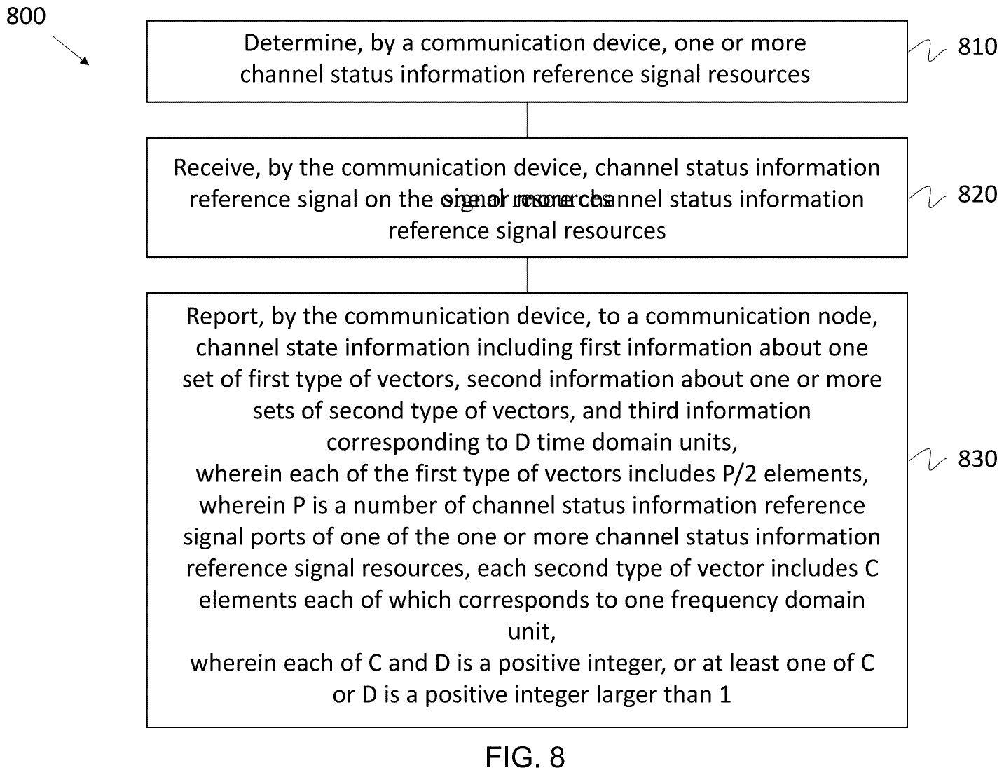

FIG. 8 shows an example of a process for wireless communication based on some example embodiments of the disclosed technology.

In some embodiments of the disclosed technology, a wireless communication method 800 includes, at 810, determining, by a communication device, one or more channel status information reference signal resources, at 820, receiving, by the communication device, channel status information reference signal on the one or more channel status information reference signal resources, and, at 830, reporting, by the communication device, to a communication node, channel state information including first information about one set of first type of vectors, second information about one or more sets of second type of vectors, and third information corresponding to D time domain units, wherein each of the first type of vectors includes P/2 elements, wherein P is a number of channel status information reference signal ports of one of the one or more channel status information reference signal resources, each second type of vector includes C elements each of which corresponds to one frequency domain unit, wherein each of C and D is a positive integer, or at least one of C or D is a positive integer larger than 1.

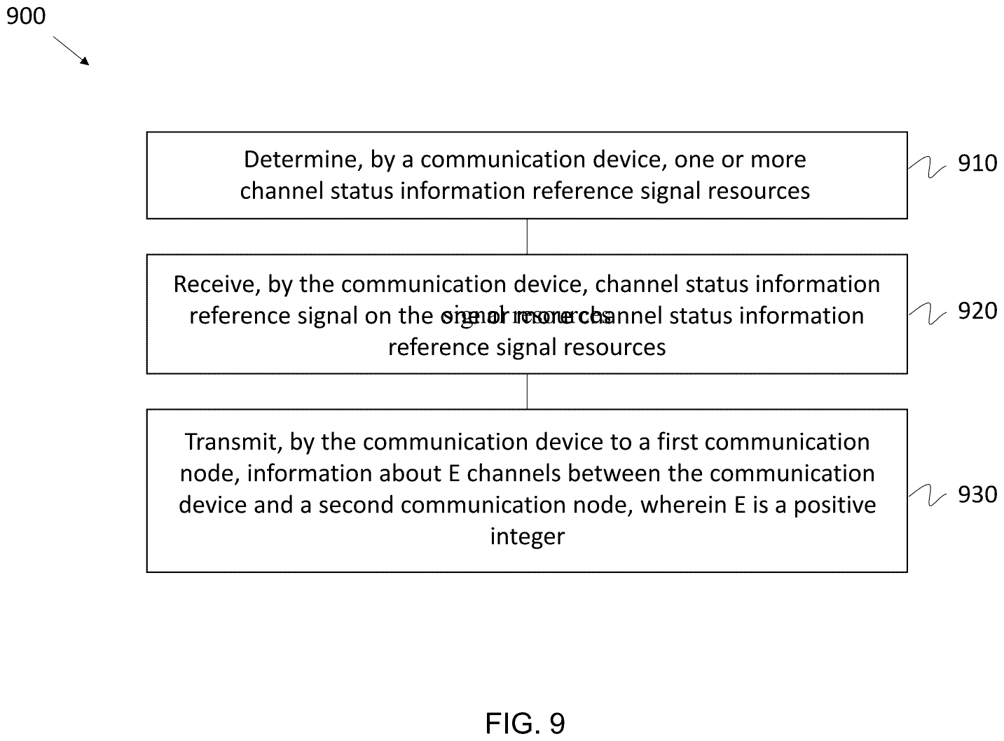

FIG. 9 shows another example of a process for wireless communication based on some example embodiments of the disclosed technology.

In some embodiments of the disclosed technology, a wireless communication method 900 includes, at 910, determining, by a communication device, one or more channel status information reference signal resources, at 920, receiving, by the communication device, channel status information reference signal on the one or more channel status information reference signal resources, and at 930, transmitting, by the communication device to a first communication node, information about E channels between the communication device and a second communication node, wherein E is a positive integer.

It will be appreciated that the present document discloses techniques that can be embodied in various embodiments to determine reference signaling and configuration in wireless networks. The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Some embodiments may preferably implement one or more of the following solutions, listed in clause-format. The following clauses are supported and further described in the embodiments above and throughout this document. As used in the clauses below and in the claims, a wireless device may be user equipment, mobile station, or any other wireless terminal including fixed nodes such as base stations. A network device includes a base station including a next generation Node B (gNB), enhanced Node B (eNB), or any other device that performs as a base station.

Clause 1. A method of communication, comprising: determining, by a communication device, one or more channel status information reference signal resources; receiving, by the communication device, channel status information reference signal on the one or more channel status information reference signal resources; and reporting, by the communication device, to a communication node, channel state information including first information about one set of first type of vectors, second information about one or more sets of second type of vectors, and third information corresponding to D time domain units, wherein each of the first type of vectors includes P/2 elements, wherein P is a number of channel status information reference signal ports of one of the one or more channel status information reference signal resources, each second type of vector includes C elements each of which corresponds to one frequency domain unit, wherein each of C and D is a positive integer, or at least one of C or D is a positive integer larger than 1.

Clause 2. The method of clause 1, wherein E precoding matrices are determined according to the channel state information for C frequency domain units and D time domain units, wherein E is equal to or larger than 1.

Clause 3. The method of clause 2, wherein the third information includes information about one or more sets of third type of vectors each of which corresponds to one of the D time domain units.

Clause 4. The method of clause 3, wherein each of the E precoding matrices is determined according to the one set of first type of vectors, the one or more sets of second type of vectors and the one or more sets of third type of vectors.

Clause 5. The method of clause 2, wherein each set of third type of vectors is specific to at least one of: one layer; one first type of vector; one second type of vector; one set of layers; one set of first type of vectors; or one set of second type of vectors.

Clause 6. The method of clause 2, wherein each set of third type of vectors is specific to at least one of: all layers; all first type of vectors; or all second type of vectors.

Clause 7. The method of any of clauses 3-6, wherein E is a product of C and D.

Clause 8. The method of any of clauses 3-7, wherein each column of each of the E precoding matrices is expressed by one of:

$${W}_{k , t}^{l} = \frac{1}{{β}_{l , k , t}} [ \begin{matrix}{\sum }_{i = 0}^{L ‐ 1} {v}_{i} {\sum }_{f = 0}^{M ‐ 1} {y}_{k , l}^{( f )} {\sum }_{x = 0}^{X ‐ 1} {s}_{l , i , f , t}^{x} {a}_{l , i , f , x} \\ {\sum }_{i = 0}^{L ‐ 1} {v}_{i} {\sum }_{f = 0}^{M ‐ 1} {y}_{k , l}^{( f )} {\sum }_{x = 0}^{X ‐ 1} {s}_{l , i , f , t}^{x} {a}_{l , i + L , f , x}\end{matrix} ]$$

$${W}_{k , t}^{l} = \frac{1}{{β}_{l , k , t}} [ \begin{matrix}{\sum }_{i = 0}^{L ‐ 1} {v}_{i} {p}_{l , 0}^{( 1 )} {\sum }_{f = 0}^{M ‐ 1} {y}_{k l}^{( f )} {\sum }_{x = 0}^{X ‐ 1} {s}_{l , i , f , t}^{x} {p}_{l , i , f , x}^{( 2 )} {φ}_{l , f , x}^{( 2 )} \\ {\sum }_{i = 0}^{L ‐ 1} {v}_{i} {p}_{l , 1}^{( 1 )} {\sum }_{f = 0}^{M ‐ 1} {y}_{k , l}^{( f )} {\sum }_{x = 0}^{X ‐ 1} {s}_{l , i , f , t}^{x} {p}_{l , i , f , x}^{( 2 )} {φ}_{l , i , f , x}^{( 2 )}\end{matrix} ]$$

$${W}_{k , t}^{l} = \frac{1}{{β}_{l , k , t}} [ \begin{matrix}{\sum }_{i = 0}^{L ‐ 1} {v}_{i} {p}_{l , 0 , x}^{( 1 )} {p}_{l , x}^{( 3 )} {\sum }_{f = 0}^{M ‐ 1} {y}_{k , l}^{( f )} {\sum }_{x = 0}^{X ‐ 1} {s}_{l , i , f , t}^{x} {p}_{l , i , f , x}^{( 2 )} {φ}_{l , f , x}^{( 2 )} \\ {\sum }_{i = 0}^{L ‐ 1} {v}_{i} {p}_{l , 1 , x}^{( 1 )} {p}_{l , x}^{( 3 )} {\sum }_{f = 0}^{M ‐ 1} {y}_{k , l}^{( f )} {\sum }_{x = 0}^{X ‐ 1} {s}_{l , i , f , t}^{x} {p}_{l , i , f , x}^{( 2 )} {φ}_{l , i , f , x}^{( 2 )}\end{matrix} ]$$

$${W}_{k , t}^{l} = \frac{1}{{β}_{l , k , t}} [ \begin{matrix}{\sum }_{i = 0}^{L ‐ 1} {v}_{i} {p}_{l , 0 , x}^{( 1 )} {\sum }_{f = 0}^{M - 1} {y}_{k , l}^{( f )} {\sum }_{x = 0}^{X ‐ 1} {s}_{l , i , f , t}^{x} {p}_{l , i , f , x}^{( 2 )} {φ}_{l , i , f , x}^{( 2 )} \\ {\sum }_{i = 0}^{L ‐ 1} {v}_{i} {p}_{l , 1 , x}^{( 1 )} {\sum }_{f = 0}^{M - 1} {y}_{k , l}^{( f )} {\sum }_{x = 0}^{X ‐ 1} {s}_{l , i , f , t}^{x} {p}_{l , i , f , x}^{( 2 )} {φ}_{l , i , f , x}^{( 2 )}\end{matrix} ]$$

$${W}_{k , t}^{l} = \frac{1}{{β}_{l , k , t}} [ \begin{matrix}{\sum }_{i = 0}^{L - 1} {v}_{i} {p}_{l , 0 , x}^{( 1 )} {p}_{l , x}^{( 3 )} {φ}_{l , x}^{( 3 )} {\sum }_{f = 0}^{M - 1} {y}_{k , l}^{( f )} {\sum }_{x = 0}^{X ‐ 1} {s}_{l , i , f , t}^{x} {p}_{l , i , f , x}^{( 2 )} {φ}_{l , f , x}^{( 2 )} \\ {\sum }_{i = 0}^{L - 1} {v}_{i} {p}_{l , 1 , x}^{( 1 )} {p}_{l , x}^{( 3 )} {φ}_{l , x}^{( 3 )} {\sum }_{f = 0}^{M - 1} {y}_{k , l}^{( f )} {\sum }_{x = 0}^{X ‐ 1} {s}_{l , i , f , t}^{x} {p}_{l , i , f , x}^{( 2 )} {φ}_{l , i , f , x}^{( 2 )}\end{matrix} ]$$

$${W}_{k , t}^{l} = \frac{1}{{β}_{l , k , t}} [ \begin{matrix}{\sum }_{i = 0}^{L - 1} {v}_{i} {p}_{l , 0 , z}^{( 1 )} {p}_{l , z}^{( 3 )} {\sum }_{f = 0}^{M - 1} {y}_{k , l}^{( f )} {\sum }_{x = 0}^{X - 1} {s}_{l , i , f , t}^{x} {p}_{l , i , f , x}^{( 2 )} {φ}_{l , i , f , x}^{( 2 )} \\ {\sum }_{i = 0}^{L - 1} {v}_{i} {p}_{l , 1 , z}^{( 1 )} {p}_{l , z}^{( 3 )} {\sum }_{f = 0}^{M - 1} {y}_{k , l}^{( f )} {\sum }_{x = 0}^{X - 1} {s}_{l , i , f , t}^{x} {p}_{l , i , f , x}^{( 2 )} {φ}_{l , i , f , x}^{( 2 )}\end{matrix} ]$$

$${W}_{k , t}^{l} = \frac{1}{{β}_{l , k , t}} [ \begin{matrix}{\sum }_{i = 0}^{L - 1} {v}_{i} {p}_{l , 0 , z}^{( 1 )} {p}_{l , z}^{( 3 )} {φ}_{l , z}^{( 3 )} {\sum }_{f = 0}^{M - 1} {y}_{k , l}^{( f )} {\sum }_{x = 0}^{X - 1} {s}_{l , i , f , t}^{x} {p}_{l , i , f , x}^{( 2 )} {φ}_{l , i , f , x}^{( 2 )} \\ {\sum }_{i = 0}^{L - 1} {v}_{i} {p}_{l , 1 , z}^{( 1 )} {p}_{l , z}^{( 3 )} {φ}_{l , z}^{( 3 )} {\sum }_{f = 0}^{M - 1} {y}_{k , l}^{( f )} {\sum }_{x = 0}^{X - 1} {s}_{l , i , f , t}^{x} {p}_{l , i , f , x}^{( 2 )} {φ}_{l , i , f , x}^{( 2 )}\end{matrix} ]$$

$$or$$

$${W}_{k , t}^{l} = \frac{1}{{β}_{l , k , t}} [ \begin{matrix}{\sum }_{i = 0}^{L - 1} {v}_{i} {p}_{l , 0 , z}^{( 1 )} {\sum }_{f = 0}^{M - 1} {y}_{k , l}^{( f )} {\sum }_{x = 0}^{X - 1} {s}_{l , i , f , t}^{x} {p}_{l , i , f , x}^{( 2 )} {φ}_{l , i , f , x}^{( 2 )} \\ {\sum }_{i = 0}^{L - 1} {v}_{i} {p}_{l , 1 , z}^{( 1 )} {\sum }_{f = 0}^{M - 1} {y}_{k , l}^{( f )} {\sum }_{x = 0}^{X - 1} {s}_{l , i , f , t}^{x} {p}_{l , i , f , x}^{( 2 )} {φ}_{l , i , f , x}^{( 2 )}\end{matrix} ]$$

wherein vᵢ is one of the first type of vectors, y_{k,l}^{(f)} is k^{th} element of one of the second type of vectors, and s_{l,i,f,t}^{x} is t^{th} element of one of the third type of vector, wherein W_{k,t}^{l} corresponds to the frequency domain unit with index k,k=0,1, . . . C−1 and t=0,1 . . . , D−1, wherein a_{l,i,f,x} is a coefficient with amplitude and phase, and p_{l,i,f,x}⁽²⁾, p_{l,0}⁽¹⁾, p_{l,1}⁽¹⁾, p_{l,x}⁽²⁾, p_{l,z}⁽²⁾, p_{l,0,x}⁽¹⁾, p_{l,1,x}⁽¹⁾, p_{l,0,z}⁽¹⁾, p_{l,1,z}⁽¹⁾ are amplitude coefficients and ϕ_{l,i,f,x}⁽²⁾, ϕ_{l,x}⁽³⁾, ϕ_{l,z}⁽³⁾ are phase coefficients, wherein z is an index of one set of the third type of vectors.

In some implementations, if y_{k,l}^{(f)} is shared by all layers, then the down subscript l of y_{k,l}^{(f)} can be deleted. Then the down subscript l can be deleted.

In some implementations, if the third type of vector is shared by all i, then the down subscript l of s_{l,i,f,t}^{x}.

In some implementations, the s_{l,i,f,t}^{x} can be replaced by one of s_{l,f,t}^{x}s_{l,t}^{x}.sₜ^{x} or sₜ^{x}.

In some implementation, β_{l,k,t} can be obtained by one of the following equations:

$${( {β}_{l , k , t} )}^{2} = v * P / 2 * {\sum }_{i = 0}^{L - 1} {( {p}_{l , i / L , x}^{( 1 )} )}^{2} {\vert {\sum }_{f = 0}^{M - 1} {y}_{k , l}^{( f )} {\sum }_{x = 0}^{X - 1} {s}_{l , i , f , t}^{x} {p}_{l , i , f , x}^{( 2 )} {φ}_{l , i , f , x}^{( 2 )} \vert}^{2}$$

$${( {β}_{l , k , t} )}^{2} = v * {\sum }_{i = 0}^{L - 1} {( {p}_{l , i / L , x}^{( 1 )} )}^{2} {\vert {\sum }_{f = 0}^{M - 1} {y}_{k , l}^{( f )} {\sum }_{x = 0}^{X - 1} {s}_{l , i , f , t}^{x} {p}_{l , i , f , x}^{( 2 )} {φ}_{l , i , f , x}^{( 2 )} \vert}^{2}$$

$${( {β}_{l , k , t} )}^{2} = v * P / 2 * {\sum }_{i = 0}^{L - 1} {( {p}_{l , i / L , x}^{( 1 )} )}^{2} {\vert {\sum }_{f = 0}^{M - 1} {y}_{k , l}^{( f )} {\sum }_{x = 0}^{X - 1} {s}_{l , i , f , t}^{x} {p}_{l , i , f , x}^{( 2 )} {φ}_{l , i , f , x}^{( 2 )} \vert}^{2}$$

$${( {β}_{l , k , t} )}^{2} = v * {\sum }_{i = 0}^{L - 1} {( {p}_{l , i / L , x}^{( 1 )} )}^{2} {\vert {\sum }_{f = 0}^{M - 1} {y}_{k , l}^{( f )} {\sum }_{x = 0}^{X - 1} {s}_{l , i , f , t}^{x} {p}_{l , i , f , x}^{( 2 )} {φ}_{l , i , f , x}^{( 2 )} \vert}^{2}$$

$${( {β}_{l , k , t} )}^{2} = v * P / 2 * {\sum }_{i = 0}^{L - 1} {( {p}_{l , i / L , x}^{( 1 )} {p}_{l , x}^{( 3 )} )}^{2} {\vert {\sum }_{f = 0}^{M - 1} {y}_{k , l}^{( f )} {\sum }_{x = 0}^{X - 1} {s}_{l , i , f , t}^{x} {p}_{l , i , f , x}^{( 2 )} {φ}_{l , i , f , x}^{( 2 )} \vert}^{2}$$

$${( {β}_{l , k , t} )}^{2} = v * {\sum }_{i = 0}^{L - 1} {( {p}_{l , i / L , x}^{( 1 )} {p}_{l , x}^{( 3 )} )}^{2} {\vert {\sum }_{f = 0}^{M - 1} {y}_{k , l}^{( f )} {\sum }_{x = 0}^{X - 1} {s}_{l , i , f , t}^{x} {p}_{l , i , f , x}^{( 2 )} {φ}_{l , i , f , x}^{( 2 )} \vert}^{2}$$

$${( {β}_{l , k , t} )}^{2} = v * P / 2 * {\sum }_{i = 0}^{L - 1} {( {p}_{l , i / L , z}^{( 1 )} {p}_{l , z}^{( 3 )} )}^{2} {\vert {\sum }_{f = 0}^{M - 1} {y}_{k , l}^{( f )} {\sum }_{x = 0}^{X - 1} {s}_{l , i , f , t}^{x} {p}_{l , i , f , x}^{( 2 )} {φ}_{l , i , f , x}^{( 2 )} \vert}^{2}$$

$${( {β}_{l , k , t} )}^{2} = v * {\sum }_{i = 0}^{L - 1} {( {p}_{l , i / L , z}^{( 1 )} {p}_{l , z}^{( 3 )} )}^{2} {\vert {\sum }_{f = 0}^{M - 1} {y}_{k , l}^{( f )} {\sum }_{x = 0}^{X - 1} {s}_{l , i , f , t}^{x} {p}_{l , i , f , x}^{( 2 )} {φ}_{l , i , f , x}^{( 2 )} \vert}^{2}$$

wherein v is number of layers configured by the communication node or reported by the communicated device.

Clause 9. The method of clause 8, wherein y_{k,l}^{(f)} is expressed by

$${y}_{k}^{( 1 )} = {e}^{j \frac{2 π {n}_{3 , l}^{f} k}{C}} {n}_{3 , l}^{f} ∈ \{ 0 , 1 , … C - 1 \} .$$

Clause 10. The method of clause 8, wherein s_{l,i,f,t}^{x} is expressed by one of:

$${s}_{l , i , f , t}^{x} = {e}^{j 2 π \frac{{u}_{l , i , {f}^{t}}^{x}}{D}} ,$$

$${u}_{l , i , f}^{x} ∈ \{ 0 , 1 , … , D - 1 \} ;$$

$$or$$

$${s}_{l , i , f , t}^{x} = {e}^{j 2 π \frac{{u}_{l , i , {f}^{t}}^{x}}{D * Q}} ,$$

$${u}_{l , i , f}^{x} ∈ \{ 0 , 1 , … , D * Q - 1 \} ,$$

wherein Q is an integer that is equal to or larger than 1.

Clause 11. The method of clause 8, wherein, for each layer, the channel state information further includes index i*ₗ, f*ₗ, x*ₗ of one strongest

$${p}_{l , {i}_{l}^{*} , {f}_{l}^{*} , {x}_{l}^{*}}^{( 2 )} = {max}_{i , f , x} {p}_{l , i , f , x}^{( 2 )}$$

and the channel state information does not include the amplitude value of p_{l,i*}_{ₗ}_{,f*}_{ₗ}_{,x*}_{ₗ}⁽²⁾ which is equal to 1.

Clause 12. The method of clause 8, wherein, for each third type of vector of each layer, the channel state information further includes index i*_{l,x}, f_{l,x}, x*_{l,x} of one strongest

$${p}_{l , {i}_{l}^{*} , {f}_{l}^{*} , {x}_{l}^{*}}^{( 2 )} = {max}_{i , f , x} {p}_{l , i , f , x}^{( 2 )}$$

and the channels state information does not include the amplitude value of p_{l,i*}_{ₗ}_{,f*}_{ₗ}_{,x}⁽²⁾ which is equal to 1.

Clause 13. The method of clause 8, wherein, for each layer, the channel state information includes one bitmap to indicate the reported element of p_{l,i,f,x}⁽²⁾ and φ_{l,i,f,x}⁽²⁾.

Clause 14. The method of clause 8, wherein, for each third type of vector of each layer, the channel state information includes one bitmap to indicate the reported element of p_{l,i,f,x}⁽²⁾ and φ_{l,i,f,x}⁽²⁾.

Clause 15. The method of clause 8, wherein, for each set of third type of vector of each layer, the channel state information includes one bitmap to indicate the reported element of p_{l,i,f,x}⁽²⁾ and φ_{l,i,f,x}⁽²⁾.

Clause 16. The method of any of clauses 13-15, wherein: in a case that one bit of the bitmap corresponding to one p_{l,i,f,x}⁽²⁾ and φ_{l,i,f,x}⁽²⁾ is indicated with value 1, the corresponding amplitude information p_{l,i,f,x}⁽²⁾ and phase information φ_{l,i,f,x}⁽²⁾ is included in the channel state information; or in a case that one bit of the bitmap corresponding to one p_{l,i,f,x}⁽²⁾ and φ_{l,i,f,x}⁽²⁾ is indicated with value 0, the corresponding amplitude information p_{l,i,f,x}⁽²⁾ and phase information φ_{l,i,f,x}⁽²⁾ is not included in the channel state information.

Clause 17. The method of clause 13, wherein the number of the bitmap is 2*L*M*X.

Clause 18. The method of clause 14, wherein the number of the bitmap is 2*L*M.

Clause 19. The method of clause 15, wherein the number of the bitmap is 2*L*M*X_{z}, wherein X_{z} is the number of the third type of vectors in the set with index z of the third type of vectors.

Clause 20. The method of clause 1, wherein: each of the D time domain units includes a same number of OFDM symbols; or each of the D time domain units includes a same number of slots.

Clause 21. The method of any of clauses 1-20, wherein each set of second type of vectors is specific to one of: one layer; one set of layers; or all layers.

Clause 22. The method of any of clauses 1-21, wherein each set of first type of vectors is specific to one of: one set of layers; all layers; or one set of third type of vectors.

Clause 23. The method of any of clauses 1-22, wherein the first type of vector is one of: a Discrete Fourier Transform (DFT) vector; a 2-D DFT vector; or with only one element that equals 1 and other elements that equal 0.

Clause 24. The method of any of clauses 1-23, wherein each k^{th} element of the second type vector y⁽¹⁾ with index n₃, n₃∈[0,1, . . . , C−1] is expressed by

$${y}_{k}^{( 1 )} = {e}^{j \frac{2 π {n}_{3} k}{C}} ,$$

wherein k=0,1, . . . , C and the second information includes information about n₃.

Clause 25. The method of any of clauses 3-6, 8, 12, 14-15, 19, and 22, wherein each element of the third type of vector with index is expressed by one of:

$${s}_{t} = {e}^{j 2 π \frac{ut}{D}} ,$$

$$u ∈ \{ 0 , 1 , … , D - 1 \} ;$$

$$or$$

$${s}_{t} = {e}^{j 2 π \frac{ut}{D * Q}} ,$$

$$u ∈ \{ 0 , 1 , … , D * Q - 1 \} ,$$

wherein t=0,1 . . . , D−1 and the third information includes information about u and wherein Q is an integer that is equal to or larger than 1.

Clause 26. The method of any of clauses 1-25, wherein the size of one time domain unit is determined according at least one of sub-carrier space, or a received signaling.

Clause 27. The method of clause 2, wherein the third information include D sets of information about coefficients, wherein each of the D sets of information about coefficients corresponds to one of the D time domain units and corresponds to C of the E precoding matrices.

Clause 28. The method of clause 27, wherein for each of the D time domain units, each l^{th} column of each of the C precoding matrices corresponding to the corresponding time domain unit is expressed by

$${W}_{k , t}^{l} = \frac{1}{{β}_{l , k , t}} [ \begin{matrix}{\sum }_{i = 0}^{L - 1} {v}_{i} {p}_{l , 0 , t}^{( 1 )} {\sum }_{f = 0}^{M - 1} {y}_{k , l}^{( f )} {p}_{l , i , f , t}^{( 2 )} {φ}_{l , i , f , t}^{( 2 )} \\ {\sum }_{i = 0}^{L - 1} {v}_{i} {p}_{l , 1 , t}^{( 1 )} {\sum }_{f = 0}^{M - 1} {y}_{k , l}^{( f )} {p}_{l , i , f , t}^{( 2 )} {φ}_{l , i , f , t}^{( 2 )}\end{matrix} ] ,$$

wherein vᵢ is one of the first type of vectors and y_{k,l}^{(f)} is k^{th} element of one of the second type of vectors,
wherein W_{k,t}^{l} corresponds to the frequency domain unit with index k,k=0,1, . . . C−1 and t=0,1 . . . , D−1,
wherein p_{l,0,t}⁽¹⁾,p_{l,1,t}⁽¹⁾,p_{l,i,f,t}⁽²⁾ are amplitude coefficients and φ_{l,i,f,t}⁽²⁾ is a phase coefficient, the one set of information about coefficients corresponding to time unit t includes information about p_{l,0,t}⁽¹⁾,p_{l,1,t}⁽¹⁾,p_{l,i,f,t}⁽²⁾ φ_{l,i,f,t}⁽²⁾, and index corresponding to one strongest coefficient for each layer, wherein the first information includes an index of Vᵢ, and the second information includes an index of y_{k,l}^{f}.

Clause 29. The method of clause 27, wherein the third information includes D sets of channel quality indicator (CQI) or D sets of reference signal received power (RSRP).

Clause 30. The method of clause 27 or 29, wherein each of the D sets of at least one of information about coefficients, or CQI is reported in one respective reporting time, or the D sets of at least one of information about coefficients, or CQI are reported in one reporting time.

Clause 31. The method of any of clauses 1-30, wherein the first information and the second information are a period reported using a first period, and the third information is a period reported using a second period.

Clause 32. The method of clause 31, wherein one first period includes D second periods.

Clause 33. The method of any of clauses 1-32, wherein the first information and the second information for all D time domain units are same, and each of the D time unit corresponds to the respective third information and each of D sets of third time information is reported in the respective reporting time, or D sets of third time information are reported in one reporting time.

Clause 34. The method of clause 23, wherein the first information, the second information and the third information for all D time domain units are same.

Clause 35. A method of communication, comprising: determining, by a communication device, one or more channel status information reference signal resources; receiving, by the communication device, channel status information reference signal on the one or more channel status information reference signal resources; and transmitting, by the communication device to a first communication node, information about E channels between the communication device and a second communication node, wherein E is a positive integer.

Clause 36. The method of clause 35, wherein each of the E channels corresponds to one frequency domain unit and one time domain unit.

Clause 37. The method of clause 36, wherein E equals C*D wherein C is the

number of frequency domain units and D is the number of time domain units.

Clause 38. The method of clause 37, wherein each of the E channels has a format,

wherein the format includes at least one of:

$${H}_{k , t} = {\sum }_{j = 0 , q = j}^{J - 1} {b}_{k , j , t} * {U}_{k , j} * {( {W}_{k , q} )}^{H} ; \\ {H}_{k , t} = {\sum }_{j = 0 , j = q}^{J - 1} {b}_{k , j , t} * {U}_{j} * {( {W}_{q} )}^{H} ; or \\ {h}_{k , t , rx , tx} = {\sum }_{t = 0}^{D - 1} {a}_{t , rx , tx} {e}^{hj \frac{2 π kt}{D}} ,$$

wherein Uⱼ is a fourth type of vector including R elements, wherein R is a positive integer, Vⱼ is a fifth type of vector which includes P elements, wherein P is a number of CSI-RS ports in one of the one or more CSI-RS resources, k=0,1, . . . C−1 is an index of the frequency domain unit, t=0,1, . . . D−1 is an index of the time domain unit, rx=0,1, . . . R−1 is a receiving antenna port index at the communication device, tx=0,1, . . . P−1 is a CSI-RS port of one of the one or more CSI-RS port resources.

Clause 39. The method of clause 37, wherein R is the number of received antenna ports at the communication node.

Clause 40. The method of clause 37, wherein b_{k,j,t} has a format including:

$${b}_{k , j , t} = {\sum }_{{x}_{j} = 0}^{{X}_{j}} {p}_{{x}_{j}} {φ}_{{x}_{j}} {s}_{t}^{{x}_{j}} ,$$

wherein pₓ_{ⱼ} is an amplitude coefficient and φₓ_{ⱼ} is a phase coefficient, and sₜ^{x}^{ⱼ} is t^{th} element of a third type of vector s^{x}^{ᵢ}.

Clause 41. The method of clause 38, wherein

$${s}_{t}^{{x}_{j}} = {e}^{j 2 π \frac{{x}^{{x}_{j}} t}{D}} , {u}^{{x}_{j}} ∈ \{ 0 , 1 , … , D - 1 \} ; or \\ {s}_{t}^{{x}_{j}} = {e}^{j 2 π \frac{{u}^{{x}_{j}} t}{D * Q}} , u ∈ \{ 0 , 1 , … , D * Q - 1 \} ,$$

wherein t=0,1, . . . , D−1 and the third information includes information about u and wherein Q is an integer that is equal to or larger than 1.

Clause 42. The method of clause 38, wherein:

$${U}_{k , j} = \frac{1}{{β}_{l , ki , t}} [ \begin{matrix}{\sum }_{i = 0}^{L - 1} {u}_{i} {p}_{l , 0 , j}^{( 1 )} {\sum }_{f = 0}^{M - 1} {y}_{k , l}^{( f )} {p}_{l , i , f , j}^{( 2 )} {φ}_{l , i , f , j}^{( 2 )} \\ {\sum }_{i = 0}^{L - 1} {u}_{i} {p}_{l , 1 , j}^{( 1 )} {\sum }_{f = 0}^{M - 1} {y}_{k , l}^{( f )} {p}_{l , i , f , j}^{( 2 )} {φ}_{l , i , f , j}^{( 2 )}\end{matrix} ]$$

Clause 43. The method of clause 39, wherein:

$${W}_{k , q} = [ \begin{matrix}{\sum }_{i = 0}^{L - 1} {u}_{i} {p}_{l , 0 , q}^{( 1 )} {\sum }_{f = 0}^{M - 1} {y}_{k , l}^{( f )} {p}_{l , i , f , q}^{( 2 )} {φ}_{l , i , f , q}^{( 2 )} \\ {\sum }_{i = 0}^{L - 1} {u}_{i} {p}_{l , 1 , q}^{( 1 )} {\sum }_{f = 0}^{M - 1} {y}_{k , l}^{( f )} {p}_{l , i , f , q}^{( 2 )} {φ}_{l , i , f , q}^{( 2 )}\end{matrix} ]$$

Clause 44. An apparatus for wireless communication comprising a processor that is configured to carry out the method of any of clauses 1 to 43.

Clause 45. A non-transitory computer readable medium having code stored thereon, the code when executed by a processor, causing the processor to implement a method recited in any of clauses 1 to 43.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub- combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1. A method of communication, comprising:
determining, by a communication device, one or more channel status information reference signal resources;
receiving, by the communication device, channel status information reference signal on the one or more channel status information reference signal resources; and
reporting, by the communication device, to a communication node, channel state information including first information about one set of first type of vectors shared by all layers, second information about one or more sets of second type of vectors, and third information corresponding to D time domain units,
wherein each set of the one or more sets of second type of vectors is specific to one layer,
wherein the first information, the second information and the third information for all of the D time domain units are same,
wherein each of the first type of vectors includes P/2 elements, wherein P is a number of channel status information reference signal ports of one of the one or more channel status information reference signal resources, each second type of vector includes C elements each of which corresponds to one frequency domain unit,
wherein each of C and D is a positive integer, or at least one of C or D is a positive integer larger than 1.

2. The method of claim 1, wherein E precoding matrices are determined according to the channel state information for C frequency domain units and D time domain units, wherein E is equal to or larger than 1 and E is a product of C and D.

3. The method of claim 2, wherein the third information includes information about one or more sets of third type of vectors each of which corresponds to the D time domain units,
wherein each of the one or more sets of third type of vectors is specific to one laver, and each of the E precoding matrices is determined according to the one set of first type of vectors, the one or more sets of second type of vectors and the one or more sets of third type of vectors.

4-7. (canceled)

8. The method of claim 3, wherein each l^{th} column of each of the E precoding matrices is expressed by:
$${W}_{k , t}^{l} = \frac{1}{{β}_{l , k , t}} [ \begin{matrix}{\sum }_{i = 0}^{L - 1} {v}_{i} {p}_{l , 0}^{( 1 )} {\sum }_{f = 0}^{M - 1} {y}_{k , l}^{( f )} {\sum }_{x = 0}^{X - 1} {s}_{l , t}^{x} {p}_{l , i , f , x}^{( 2 )} {φ}_{l , i , f , x}^{( 2 )} \\ {\sum }_{i = 0}^{L - 1} {v}_{i} {p}_{l , 1}^{( 1 )} {\sum }_{f = 0}^{M - 1} {y}_{k , l}^{( f )} {\sum }_{x = 0}^{X - 1} {s}_{l , t}^{x} {p}_{l , i , f , x}^{( 2 )} {φ}_{l , i , f , x}^{( 2 )}\end{matrix} ]$$
wherein vᵢ is one of the first type of vectors, y_{k,l}^{(f)} is k^{th} element of one of the second type of vectors, and s_{l,t}^{x} is t^{th} element of one of the third type of vector,
wherein W_{k,t}^{l} corresponds to the frequency domain unit with index k,k=0,1, . . . C−1 and t=0,1 . . . , D−1,
wherein p_{l,i,f,x}⁽²⁾,p_{l,0}⁽¹⁾,p_{l,1}⁽¹⁾, are amplitude coefficients and ϕ_{l,i,f,x}⁽²⁾ is a phase coefficient,
wherein y_{k,l}^{(f)} is expressed by
$${y}_{k}^{( 1 )} = {e}^{j \frac{2 π {n}_{3 , l}^{f} k}{C}} {n}_{3 , l}^{f} ∈ \{ 0 , 1 , … . C - 1 \} .$$

9. (canceled)

10. The method of claim 8, wherein s_{l,t}^{x} is expressed by:
$${s}_{l , t}^{x} = {e}^{j 2 π \frac{{u}_{l}^{x} t}{D}} , {u}_{l}^{x} ∈ \{ 0 , 1 , … , D - 1 \}$$

11. The method of claim 8, wherein, for each layer, the channel state information further includes index i*ₗ,f*ₗ,x*ₗ of one strongest
$${p}_{l , {i}_{l}^{*} , {f}_{l}^{*} , {x}_{l}^{*}}^{( 2 )} = {max}_{i , f , x} {p}_{l , i , f , x}^{( 2 )}$$
and the channel state information does not include the amplitude value of p_{l,i*}_{ₗ}_{,f*}_{ₗ}_{,x*}_{ₗ} which is equal to 1.

12. (canceled)

13. The method of claim 8, wherein, for each layer, the channel state information includes one bitmap to indicate the reported element of P_{l,i,f,x}⁽²⁾ and φ_{l,i,f,x}⁽²⁾, wherein the number of the bitmap is 2*L*M*X,
in a case that one bit of the bitmap corresponding to one p_{l,i,f,x}⁽²⁾ and φ_{l,i,f,x}⁽²⁾ is indicated with value 1, a corresponding amplitude information p_{l,i,f,x}⁽²⁾ and phase information φ_{l,i,f,x}⁽²⁾ is included in the channel state information; or
in a case that one bit of the bitmap corresponding to one p_{l,i,f,x}⁽²⁾ and φ_{l,i,f,x}⁽²⁾ is indicated with value 0, the corresponding amplitude information p_{l,i,f,x}⁽²⁾ and phase information φ_{l,i,f,x}⁽²⁾ is not included in the channel state information.

14. The method of claim 8, wherein, for each third type of vector of each layer, the channel state information includes one bitmap to indicate the reported element of P_{l,i,f,x}⁽²⁾ and φ_{l,i,f,x}⁽²⁾, wherein the number of the bitmap is 2*L*M,
in a case that one bit of the bitmap corresponding to one p_{l,i,f,x}⁽²⁾ and φ_{l,i,f,x}⁽²⁾ is indicated with value 1, a corresponding amplitude information p_{l,i,f,x}⁽²⁾ phase information φ_{l,i,f,x}⁽²⁾ is included in the channel state information; or
in a case that one bit of the bitmap corresponding to one p_{l,i,f,x}⁽²⁾ and φ_{l,i,f,x}⁽²⁾ is indicated with value 0, the corresponding amplitude information p_{l,i,f,x}⁽²⁾ and phase information φ_{l,i,f,x}⁽²⁾ is not included in the channel state information.

15-19. (canceled)

20. The method of claim 1, wherein:
each of the D time domain units includes a same number of slots.

21-24. (canceled)

25. The method of claim 3, wherein each t^{th} element of the third type of vector with index u is expressed by:
$${s}_{t} = {e}^{j 2 π \frac{ut}{D}} , u ∈ \{ 0 , 1 , … , D - 1 \}$$
wherein t=0,1, . . . , D−1 and the third information includes information about u.

26. The method of claim 1, wherein a size of one time domain unit is determined according to a received signaling.

27-44. (canceled)

45. A non-transitory computer readable medium having code stored thereon, the code when executed by a processor, causing the processor to implement a method, comprising:
determining, by a communication device, one or more channel status information reference signal resources;
receiving, by the communication device, channel status information reference signal on the one or more channel status information reference signal resources; and
reporting, by the communication device, to a communication node, channel state information including first information about one set of first type of vectors shared by all layers, second information about one or more sets of second type of vectors, and third information corresponding to D time domain units,
wherein each set of the one or more sets of second type of vectors is specific to one layer,
wherein the first information, the second information and the third information for all of the D time domain units are same,
wherein each of the first type of vectors includes P/2 elements, wherein P is a number of channel status information reference signal ports of one of the one or more channel status information reference signal resources, each second type of vector includes C elements each of which corresponds to one frequency domain unit,
wherein each of C and D is a positive integer, or at least one of C or D is a positive integer larger than 1.

46. The non-transitory computer readable medium of claim 45, wherein E precoding matrices are determined according to the channel state information for C frequency domain units and D time domain units, wherein E is equal to or larger than 1 and E is a product of C and D, wherein the third information includes information about one or more sets of third type of vectors each of which corresponds to the D time domain units, wherein each t^{h} element of the third type of vector with index u is expressed by:
$${s}_{t} = {e}^{j 2 π \frac{ut}{D}} , u ∈ \{ 0 , 1 , … , D - 1 \} ,$$
wherein t=0,1, . . . , D−1 and the third information includes information about u, wherein each of the one or more sets of third type of vectors is specific to one layer, and each of the E precoding matrices is determined according to the one set of first type of vectors, the one or more sets of second type of vectors and the one or more sets of third type of vectors.

47. The non-transitory computer readable medium of claim 45, wherein:
each of the D time domain units includes a same number of slots;
a size of one time domain unit is determined according to a received signaling; or
each of the D time domain units includes a same number of slots and the size of one time domain unit is determined according to a received signaling.

48. The non-transitory computer readable medium of claim 46, wherein each l^{th} column of each of the E precoding matrices is expressed by:
$${W}_{k , t}^{l} = \frac{1}{{β}_{l , k , t}} [ \begin{matrix}{\sum }_{i = 0}^{L - 1} {v}_{i} {p}_{l , 0}^{( 1 )} {\sum }_{f = 0}^{M - 1} {y}_{k , l}^{( f )} {\sum }_{x = 0}^{X - 1} {s}_{l , t}^{x} {p}_{l , i , f , x}^{( 2 )} {φ}_{l , i , f , x}^{( 2 )} \\ {\sum }_{i = 0}^{L - 1} {v}_{i} {p}_{l , 1}^{( 1 )} {\sum }_{f = 0}^{M - 1} {y}_{k , l}^{( f )} {\sum }_{x = 0}^{X - 1} {s}_{l , t}^{x} {p}_{l , i , f , x}^{( 2 )} {φ}_{l , i , f , x}^{( 2 )}\end{matrix} ] ;$$
wherein vᵢ is one of the first type of vectors, y_{k,l}^{(f)} is k^{th} element of one of the second type of vectors, and s_{l,t}^{x} is t^{th} element of one of the third type of vector,
wherein W_{k,t}^{l} corresponds to the frequency domain unit with index k,k=0,1, . . . C−1 and t=0,1 . . . , D−1,
wherein p_{l,i,f,x}⁽²⁾, p_{l,0}⁽¹⁾,p_{l,1}⁽¹⁾ are amplitude coefficients and ϕ_{l,i,f,x}⁽²⁾ is a phase coefficient,
wherein y_{k,l}^{(f)} is expressed by
$${y}_{k}^{( 1 )} = {e}^{j \frac{2 π {n}_{3 , l}^{f} k}{C}} {n}_{3 , l}^{f} ∈ \{ 0 , 1 , … . C - 1 \} .$$

49. The non-transitory computer readable medium of claim 48, wherein, for each layer, the channel state information further includes index i*ₗ,f*ₗ,x*ₗ of one strongest
$${p}_{l , {i}_{l}^{*} , {f}_{l}^{*} , {x}_{l}^{*}}^{( 2 )} = {max}_{i , f , x} {p}_{l , i , f , x}^{( 2 )}$$
and the channel state information does not include the amplitude value of p_{l,i*}_{ₗ}_{,f*}_{ₗ}_{,x*}_{ₗ} which is equal to 1.

50. The non-transitory computer readable medium of claim 48, wherein, for each layer, the channel state information includes one bitmap to indicate the reported element of p_{l,i,f,x}⁽²⁾ and φ_{l,i,f,x}⁽²⁾, wherein the number of the bitmap is 2*L*M*X, wherein: in a case that one bit of the bitmap corresponding to one p_{l,i,f,x}⁽²⁾ and φ_{l,i,f,x}⁽²⁾ is indicated with value 1, a corresponding amplitude information p_{l,i,f,x}⁽²⁾ and phase information φ_{l,i,f,x}⁽²⁾ is included in the channel state information; or in a case that one bit of the bitmap corresponding to one p_{l,i,f,x}⁽²⁾ and φ_{l,i,f,x}⁽²⁾ is indicated with value 0, the corresponding amplitude information p_{l,i,f,x}⁽²⁾ and phase information φ_{l,i,f,x}⁽²⁾ is not included in the channel state information.

51. A non-transitory computer readable medium having code stored thereon, the code when executed by a processor, causing the processor to implement a method, comprising:
transmitting, by a communication node, channel status information reference signal on one or more channel status information reference signal resources; and
receiving, by the communication node from a communication device, channel state information including first information about one set of first type of vectors shared by all layers, second information about one or more sets of second type of vectors, and third information corresponding to D time domain units,
wherein each set of the one or more sets of second type of vectors is specific to one layer,
wherein the first information, the second information and the third information for all of the D time domain units are same,
wherein each of the first type of vectors includes P/2 elements, wherein P is a number of channel status information reference signal ports of one of the one or more channel status information reference signal resources, each second type of vector includes C elements each of which corresponds to one frequency domain unit,
wherein each of C and D is a positive integer, or at least one of C or D is a positive integer larger than 1.

52. A method of communication, comprising:
transmitting, by a communication node, channel status information reference signal on one or more channel status information reference signal resources; and
receiving, by the communication node from a communication device, channel state information including first information about one set of first type of vectors shared by all layers, second information about one or more sets of second type of vectors, and third information corresponding to D time domain units,
wherein each set of the one or more sets of second type of vectors is specific to one layer,
wherein the first information, the second information and the third information for all of the D time domain units are same,
wherein each of the first type of vectors includes P/2 elements, wherein P is a number of channel status information reference signal ports of one of the one or more channel status information reference signal resources, each second type of vector includes C elements each of which corresponds to one frequency domain unit,
wherein each of C and D is a positive integer, or at least one of C or D is a positive integer larger than 1.

53. The method of claim 52, wherein E precoding matrices are determined according to the channel state information for C frequency domain units and D time domain units, wherein E is equal to or larger than 1 and E is a product of C and D, wherein the third information includes information about one or more sets of third type of vectors each of which corresponds to the D time domain units, wherein each t^{th} element of the third type of vector with index u is expressed by:
$${s}_{t} = {e}^{j 2 π \frac{ut}{D}} , u ∈ \{ 0 , 1 , … , D - 1 \} ,$$
wherein t=0,1, . . . , D−1 and the third information includes information about u, wherein each of the one or more sets of third type of vectors is specific to one layer, and each of the E precoding matrices is determined according to the one set of first type of vectors, the one or more sets of second type of vectors and the one or more sets of third type of vectors.
